(19) United States
(12) Patent Application Publication
(10) Pub. No.: US 2006/0235556 A1
(43) Pub. Date: Oct. 19, 2006

(54) Holistic solid free-form fabrication process optimization method

(76) Inventors: Ralph L. Resnick, Slickville, PA (US); Howard A. Kuhn, Johnstown, PA (US)

Correspondence Address: IP & INTERNET LAW NORTH, LLC, P.O. BOX 38, ZELIENOPLE, PA, 16063, US

(21) Appl. No.: 10/561,746

(22) PCT Filed: Mar. 30, 2005
(86) PCT No.: PCT/US05/10723

§ 371 Date: Dec. 21, 2005

Related U.S. Application Data
(60) Provisional application No. 60/570,001, filed on May 10, 2004.

(51) Int. Cl. G06F 19/00

(52) U.S. Cl. 700/98; 700/118

(57) ABSTRACT

The present invention relates to methods for producing articles by solid free-form fabrication processes. In particular, the present invention relates to such methods incorporating holistic optimization of the product and process design.

### TECHNICAL FIELD

The present invention relates to methods for producing articles by solid free-form fabrication processes. In particular, the present invention relates to such methods incorporating holistic optimization of the product and process design.

### BACKGROUND ART

In recent years, solid free-form fabrication processes have been developed for producing a solid article directly from an electronic representation of the article. The term “solid free-form fabrication process” as used herein and in the appended claims refers to any process that results in a useful, three-dimensional article and includes a step of sequentially forming the shape of the article one layer at a time. Solid free-form fabrication processes are also known in the art “layered manufacturing processes.” They are also sometimes referred to in the art as “rapid prototyping processes” when the layer-by-layer building process is used to produce a small number of a particular article. A solid free-form fabrication process may include one or more post-shape forming operations that enhance the physical and/or mechanical properties of the article. Preferred solid free-form fabrication processes include the three-dimensional printing (“3DP”) process and the Selective Laser Sintering (“SLS”) process. An example of the 3DP process may be found in U.S. Pat. No. 6,036,777 to Sachs, issued Mar. 14, 2000. An example of the SLS process may be found in U.S. Pat. No. 5,076,869 to Bourell et al., issued Dec. 31, 1991. Solid free-form fabrication processes in accordance with the present invention can be used to produce articles comprised of metal, polymeric, ceramic, or composite materials.

The development of solid free-form fabrication processes has produced a quantum jump reduction in the time and costs incurred in going from concept to manufactured article by eliminating costly and time-consuming intermediate steps that were traditionally necessary. Nonetheless, the overall gain in efficiencies from the use of solid free-form fabrication processes has been hampered by traditional serial approaches to product and process design optimization.

Such serial approaches look first to define the properties of the article that is be produced in a manner that seeks to optimize the properties in terms of material selection and structural and functional design with regard to the performance of the article in its intended application. The processes for producing the article are then selected and then each step is sequentially focused upon with the aim of optimizing its efficiency.

The underlying philosophy behind such traditional serial approaches is that the efficiency of the overall design and production process equals the sum of the efficiencies of the individual design and process steps. That is, the whole is no more than the sum of its individual parts. Thus, the overall system efficiency is optimized only when the efficiency of each step has been optimized.

However, the traditional serial approaches fail to realize the possibility of further increases in efficiency that may be obtainable from synergistic effects. Indeed, the traditional serial approaches actually suffer from inefficiencies that result from negative synergisms that occur when the optimization of one step results in making another step or steps in the design and production process less efficient. In time, through iterative sequence of product and process refinements, such negative synergistic effects may be reduced or eliminated. Yet, the costs and time associated with such refinements add to the overall cost and time expended on the development of the product and process design.

### DISCLOSURE OF INVENTION

It is a goal of the present invention to further improve on the benefit of the reduction of cost and time derivable from the employment of solid free-form fabrication processes in going from concept to manufactured article. The present invention achieves this goal by employing methods which holistically optimize product and process design for articles produced by a solid free-form fabrication process.

In the present invention, the product and process design for such articles is considered as a single enterprise, rather than a collection of individual steps. Thus, the term “holistically” as used herein and in the appended claims means considering all aspects of the enterprise as a whole and the interdependence of its parts. Accordingly, “holistically designing the article to be made and the manufacturing process for making the article” as used herein and in the appended claims means to consider all aspects of the both the article and the manufacturing process and the interdependence of the article and the manufacturing process as well as the interdependence of each of the steps in the manufacturing process. Included among such aspects are life cycle considerations for both the article and the manufacturing process, for example, environmental impact, recycling, refabrication, and energy consumption considerations.

According to one aspect of the present invention, a method is provided in which an article to be made is first selected. In this context, the phrase “selecting an article to be made” as used herein and in the appended claims means “determining the existence of a need for an article and identifying qualitatively the characteristics the article must have in order to satisfy that need.” After the article is selected, the next step is holistically designing the article and the manufacturing process for making the article, wherein the manufacturing process includes the use of a solid free-form fabrication process. In this context, the term “designing” as used herein and in the appended claims means “determining the characteristics of an article or manufacturing process step, including the range of manufacturing tolerance of the characteristic or step.” Concurrently with or subsequent to the designing step, the designs of the article and of the manufacturing process are captured. In this context, the term “capturing” as used herein and in the appended claims means “recording by any human or machine readable or reproducible means.” Thus, the method results in a record of the design of the article to be made and of the design of the manufacturing process for making the article which have been arrived at holistically.

According to another aspect of the present invention, a method is provided by which a class of articles is first selected and then the class of articles and the manufacturing process for making them are holistically designed and captured, wherein the manufacturing process includes the use of a solid free-form fabrication process.

The holistic approach employed by the methods of the present invention inherently provides for the achievement of improved, and in some case even optimized, efficiency of the overall product and design process and the production of the article or class of articles by solid free-form fabrication. Additionally, the present invention provides the potential for quality and performance improvements in the produced articles and the manufacturing processes which result from designing holistically. In some instances, the present invention, through endeavoring to optimize the enterprise, enables articles to be produced that would not have been possible to produce through the prior art methods employing sequential optimization.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is a schematic diagram depicting a holistic design process according to an embodiment of the present invention.

FIG. 2 is a schematic diagram depicting some of the characteristics of the article design element shown in FIG. 1.

FIG. 3 is a schematic diagram depicting some of the characteristics of the manufacturing process design element shown in FIG. 1.

FIG. 4 is a schematic diagram depicting an aspect of the present invention.

### MODES FOR CARRYING OUT THE INVENTION

In this section, some presently preferred embodiments of the present invention are described in detail sufficient for one skilled in the art to practice the present invention. It is to be understood, however, that the fact that a limited number of presently preferred embodiments are described herein does not in any way limit the scope of the present invention as set forth in the appended claims.

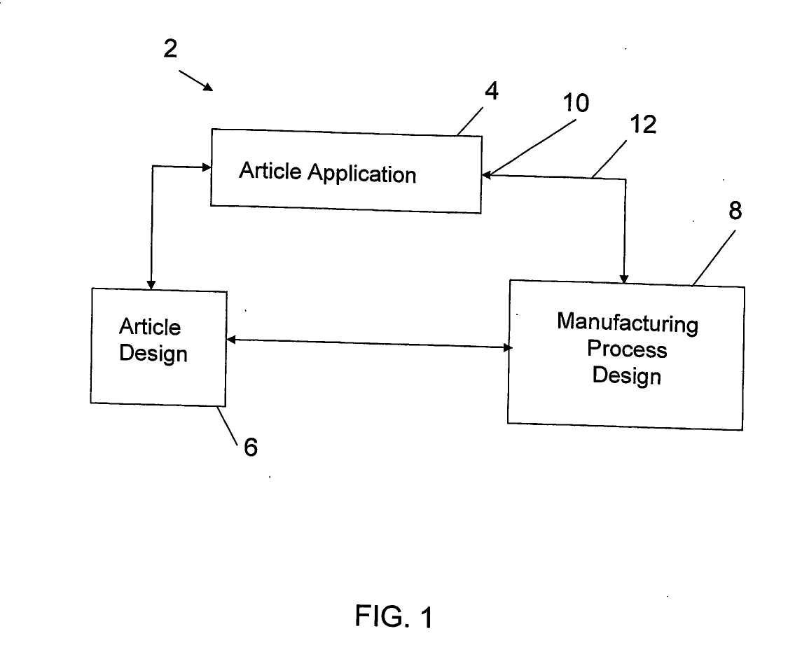

According to a preferred embodiment of the present invention, the overall enterprise consists of designing an article and the process for making the article and producing the article. The embodiment provides a means for optimizing the efficiency of the overall enterprise. In the embodiment, an article to be manufactured is first selected. Then, the holistic design process 2 depicted schematically in FIG. 1 is employed to simultaneously design both the article and the manufacturing process for making the article.

Referring to FIG. 1, holistic design process 2 involves considering the overall cost and time from article selection to article production of the following: article application 4; article design 6; and manufacturing process design 8. The arrowheads 10 on the connecting lines 12 emphasize that the interdependency of these three elements is complete and that all of these elements are considered at the same time. Although the characteristics of the article application 4 are the driving force for the development of both the article design 6 and the manufacturing process design 8, in holistic design process 2, the characteristics of the article application 4 are to be reexamined for possible modification in order to optimize the efficiency of the overall enterprise. For example, upon such reconsideration, it may be determined that the article application for a widget requires the article to have a yield strength of only 350 MPa instead of the 400 MPa initially specified, thus allowing for a use of lower cost material of construction for the article, for more energy efficient, lower temperature processing steps that can be done in less expensive furnaces and without the need for protective atmospheres, and for less expensive finishing steps. Similarly, holistic design process 2 permits the optimization of the overall enterprise by consideration of the interdependency of the article design 6 and the manufacturing process design 8 and vice versa.

It should be understood that the conceptual demarcation of article development 6 and manufacturing process development 8 is made herein only for two reasons. The first is that, historically, these two development processes have been considered to be separate endeavors and often have been pursued sequentially, sometimes with multiple iterations of the sequence. The second is that the demarcation provides a convenient framework for discussing the topic in terms that are easy to conceptually grasp. However, in the context of the present invention, any conceptual demarcation between article development 6 and manufacturing process development 8 is both artificial and arbitrary because the present invention involves the holistic design of the overall endeavor.

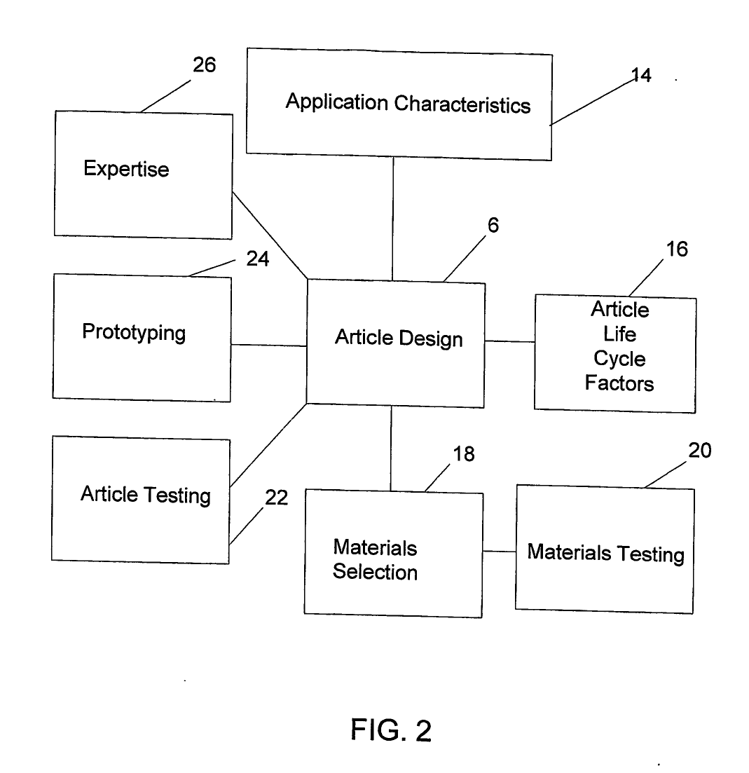

In keeping with this arbitrary distinction between the article design 6 and the manufacturing process design 8 under the present invention, reference is made to FIG. 2, which schematically depicts some of the characteristics that comprise the article design 6. These characteristics include: application characteristics 14; article life cycle factors 16; materials selection 18; materials testing 20; article testing 22; prototyping 24; and expertise 26 about the article and all technologies relevant to the article.

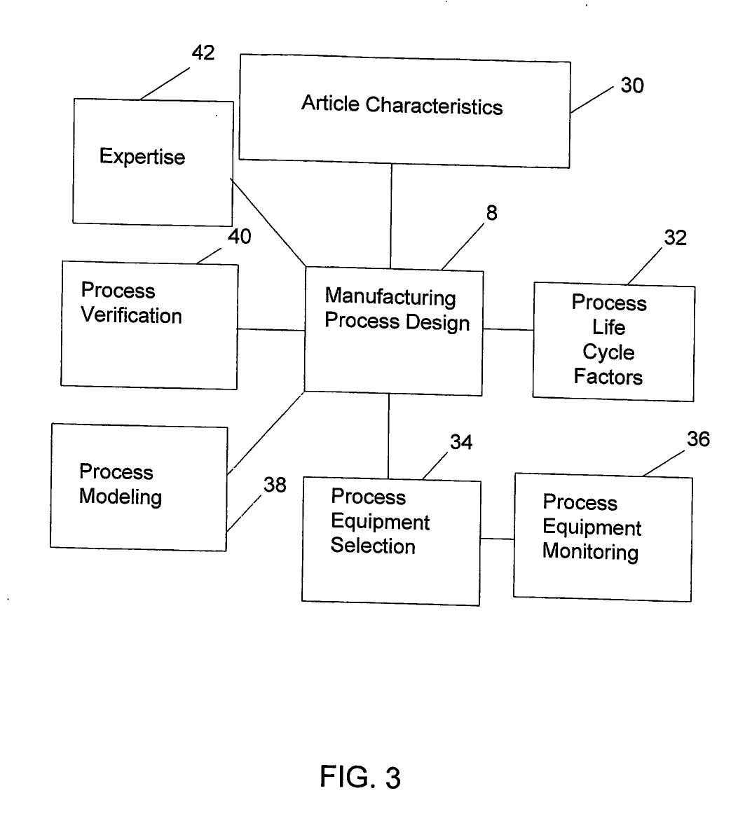

Similarly, FIG. 3 schematically depicts some of the characteristics that comprise the manufacturing process design 8. These characteristics include: article characteristics 30; process life cycle factors 32; processing equipment selection 34; process equipment monitoring 36; process modeling 38; process verification 40; and expertise 42 about the relevant processes and all technologies relevant to the relevant processes.

To both or either of the article design 6 and/or the manufacturing process design 8 can be added other parameters not shown in FIGS. 2 and 3. For example, regulatory, certification, and other compliances must also be addressed in both or either article design and/or manufacturing process design.

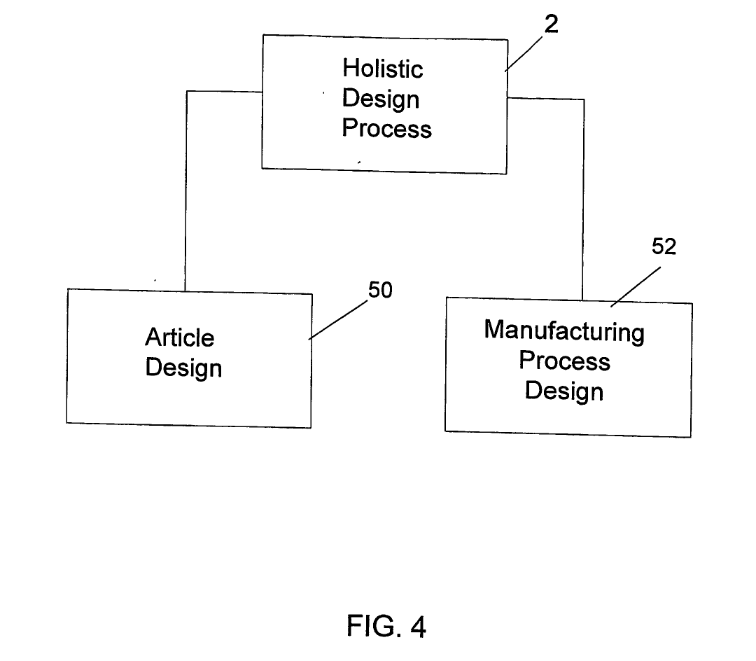

As depicted schematically in FIG. 4, the employment of holistic design process 2 results in an article design 50 and a manufacturing process design 52. In the preferred embodiment of the present invention, these resulting designs are captured so that they may be used for manufacturing the article. The means of capture may be any that are suitable for the particular data that is being recorded. For example, recording may be done by means of making electronic records, analog chart records, manually written notes, etc.

The present invention also includes embodiments wherein a class of articles, instead of just a single article, is selected and then the class of articles and the manufacturing process are designed holistically and captured. The term “class of articles” as used herein and in the appended claims means a group of individual articles that share identity as to function and application, but differ only in particularities such as relative size and specific features which are not necessary to unifying application. One example of such a class of articles is a set of molds, each of which is usable with a particular injection molding machine. The function of each mold is the same, i.e., to receive and shape injected moldable material. The unifying application is the same, i.e., to fit a particular injection molding machine and act as the molding element thereon. However, the individual molds in this set may be different in particulars which are not necessary to this unifing application, such as the dimensions and contours of the molding surface that define the shape of the article that is to be molded. Another example of such a class is a set of cams that all have the same shape, but differ in relative size. In this case, the function of each of the cams is the same, i.e., to act as a cam. The unifying application here is to drive a contacting member along the particularly shaped path that is defined by the cam's contact surface. Particulars of the individual articles, such as relative size, that are not necessary for the cam to produce this particularly shaped path may differ from article to article within the class.

In accordance with presently preferred embodiments of the present invention, the manufacturing process design includes the use of a solid free-form fabrication process. In the example given below, the manufacturing process includes making an article by the 3DP process. Persons skilled in the art will recognize that the present invention includes the making of articles by any solid free-form fabrication process for which the articles are within the size and material capability of the particular solid free-form fabrication process. For example, some preferred embodiments employ the SLS process.

The 3DP process is conceptually similar to inkjet printing. However, instead of ink, the 3DP process deposits a binder onto the top layer of a bed of powder. This binder is printed onto the powder layer according to a two-dimensional slice of a three-dimensional electronic representation of the article that is to be manufactured. Additional powder layers are added so that one layer after another is printed until the entire article has been formed. The powder may comprise a metal, ceramic, polymer, or composite material. The binder may comprise at least one of a polymer and a carbohydrate. Examples of suitable binders are given in U.S. Pat. No. 5,076,869 to Bourell et al., issued Dec. 31, 1991, and in U.S. Pat. No. 6,585,930 to Liu et al, issued Jul. 1, 2003.

The printed article typically consists of from about 30 to over 60 volume percent powder, depending on powder packing density, and about 10 volume percent binder, with the remainder being void space. The printed article at this stage is somewhat fragile. Post-printing processing is conducted to enhance the physical and/or mechanical properties of the printed article. Post-printing processing includes thermally processing the printed article to remove the binder and to sinter together the powder particles to a desired density. The desired density may be one that provides a network of interconnected porosity suitable for receiving an infiltrant or it may be to a higher density, up to and including a full density, i.e., a density which indicates that there is no substantial amount of porosity remaining in the sintered printed article.

Post-printing processing may further include introducing an infiltrant material that subsequently hardens or solidifies, thereby producing a highly dense article having the desired physical and mechanical properties. If infiltration is employed, it is necessary to prevent the infiltrant from filling into any small diameter passages of the article. The techniques described in U.S. Pat. No. 5,775,402 to Sachs et al., issued Jul. 7, 1998, may be employed to prevent infiltrant from filling such passages in the practice of the present invention.

The three-dimensional electronic representation of the article that is used in the layered manufacturing process is typically created using Computer-Aided Design (“CAD”) software. The CAD file of the three-dimensional electronic representation is typically converted into another file format known in the industry-as stereolithographic or standard triangle language (“STL”) file format or STL format. The STL format file is then processed by a suitable slicing program to produce an electronic file that converts the three-dimensional electronic representation of the article into another format file comprising the article represented as two-dimensional slices. The thickness of the slices is typically in the range of about 0.008 cm (0.003 inches) to about 0.03 cm (0.012 inches), but may be substantially different from this range depending on the design criterion for the article that is being made and the particular layered manufacturing process being employed. Suitable programs for making these various electronic files are well-known to persons skilled in the art.

### EXAMPLE

In this example, the class of articles to be made is dental copings. A dental coping is the core portion of a dental crown. A dental crown is a dental prosthetic that replaces the part of the tooth that appears above the gum line. Dental copings are usually made of metal or ceramic. Layers of ceramic, which mimic tooth enamel, are applied to the side and upper surfaces of the dental coping to give the dental crown the desired surface hardness and cosmetic features.

In this case, the unifying function for the class is that each dental coping must provide the performance characteristics required of the core of a dental crown. The unifying application for the class is that each article is to be a dental coping. Thus, this is a case where the unifying function and unifying application for the class are essentially the same. It is easily seen, however, that characteristics such as size and contour vary from one dental coping to the next since every dental crown must be individualized to replicate the tooth it is replacing and to fit onto the remaining tooth stub.

Selecting dental copings as the class of articles to be made was the first step in the application of the present invention in this example. The next step was to holistically design the dental copings as a class and the manufacturing process by which they would be made. In this case, the manufacturing process included the use of the 3DP process as a solid free-form fabrication process.

The interactive holistic design process included simultaneously considering what characteristics the dental coping application required, what design features the dental copings needed to have, and what limitations and requirements there were for the manufacturing process. This resulted in the definition of the characteristics of the application, the dental copings, and the entire process for producing the dental copings that was optimized as an enterprise, all of which were recorded for future use. The manufacturing process employing 3DP was then successfully employed to make trial dental copings.

In more detail, the holistic designing of the dental copings and the manufacturing process for making them resulted in beneficial synergisms. Simultaneous consideration of the dental coping's performance requirements, the material parameters, cost and availability, the process selection and control, and environmental and regulatory requirements yielded insight into interactions that made the enterprise more efficient and effective in a relatively short development time. For example, the process utilized data from digital scans of the tooth stub to help create the CAD file used in the 3DP process for making the dental coping and to make the surface of a tooling fixture upon which the dental coping was to be sintered. A gold alloy powder infiltrated after sintering with a second gold alloy to yield an FDA approved alloy comprised the construction material system for the dental coping. This material system had the strength, corrosion-resistance, and non-toxicity properties needed for the application and was also processible in the temperature and atmosphere conditions available in typical dental laboratory furnaces. The dental coping dimensional accuracy and the gold alloy powder size were adjusted along with 3DP process parameters, such as the surface tension of the printing binder and article build geometry orientation, as part of the overall optimization of the production process. The printing binder also was designed to be free of toxic effluents so as to be friendly in dental laboratory environments. The surface of the dental coping was designed so as to have good adherence to both the ceramic that would be applied to its upper and side surfaces and to the adhesive that would hold it to the tooth stub. The 3DP equipment itself was adapted to the production requirements of a dental laboratory environment. In short, application of the present invention quickly resulted in an effective and efficient enterprise.

While only a few embodiments of the present invention have been shown and described, it will be obvious to those skilled in the art that many changes and modifications may be made thereunto without departing from the spirit and scope of the invention as described in the following claims. All United States patents referred to herein are incorporated herein by reference as if set forth in full herein.

What is claimed is:

1. A method comprising the steps of:
a) selecting an article to be made,
b) holistically designing the article and the manufacturing process for making the article, wherein the manufacturing process includes the use of a solid free-form fabrication process; and
c) capturing the resulting designs of the article and the manufacturing process.

2. The method of claim 1, further comprising the step of making the article by the manufacturing process in accordance with the captured designs of the article and the manufacturing process.

3. The method of claim 1, wherein the solid free-form fabrication process is the 3DP process.

4. The method of claim 1, wherein the solid free-form fabrication process is the SLS process.

5. The method of claim 1, wherein the step of capturing includes the use of at least one of the group consisting of electronic records, analog records, and manual writing.

6. A method comprising the steps of:
a) selecting a class of articles to be made,
b) holistically designing the class of articles and the manufacturing process for making the class of articles, wherein the manufacturing process includes the use of a solid free-form fabrication process; and
c) capturing the resulting designs of the class of articles and the manufacturing process.

7. The method of claim 6, further comprising the step of making at least one article that is a member of said class of articles by the manufacturing process in accordance with the captured designs of the class of articles and the manufacturing process.

8. The method of claim 6, wherein the solid free-form fabrication process is the 3DP process.

9. The method of claim 6, wherein the solid free-form fabrication process is the SLS process.

10. The method of claim 1, wherein the step of capturing includes the use at least one of the group consisting of electronic records, analog records, and manual writing.

11. The method of claim 6, wherein the step of capturing includes the use at least one of the group consisting of electronic records, analog records, and manual writing.
